(19) United States
(12) Patent Application Publication
(10) Pub. No.: US 2005/0220285 A1
(43) Pub. Date: Oct. 6, 2005

(54) Method and apparatus for saving energy in devices of a service provider

(76) Inventors: Thomas Plarre, Holzkirchen (DE); Martin Steininger, A-Wien (AT)

Correspondence Address: Siemens Corporation;Intellectual Property Department, 170 Wood Avenue South, Iselin, NJ, 08830, US

(21) Appl. No.: 10/516,126

(22) PCT Filed: May 26, 2003
(86) PCT No.: PCT/EP03/05483

§ 371 Date: Nov. 29, 2004

(30) Foreign Application Priority Data
May 29, 2002 (EP) 02011896.4

(51) Int. Cl. H04M 3/42

(52) U.S. Cl. 379/202.01; 379/218.01

(57) ABSTRACT

Method and device for energy saving in equipment of a service provider A method and a device are described for energy saving in equipment of a service provider (SP) which, with the aid of said equipment, provides a service in at least partially sequential order to multiple service users (SUx). Here, an appointment of a service user (SUx) with the service provider is entered in a queue (Q) and an address of the service user (SUx) in a telecommunications network is assigned to said appointment. An anticipated travel time of the service user (SUx) is additionally assigned to said appointment. In consequence, a message concerning the appointment is transmitted to the address of the service user (SUx), the appointment and the anticipated travel time being taken into account in determining the transmit time. It is thus ensured that the service user (SUx) is actually ready to use the service at an agreed appointment.

The invention relates to a method for energy saving in equipment of a service provider which, with the aid of said equipment, provides a service in at least partially sequential order to multiple service users,
wherein an appointment, in particular a variable appointment, of a service user with the service provider is entered in a queue and
wherein an address of the service user in a telecommunications network is assigned to this appointment.
   In addition, the invention relates to a device for implementing the method according to the invention.

Service providers frequently face the problem that a service user, possibly despite agreeing an appointment, is not ready to use a service. This applies in particular to service providers which process the service users in at least a partially sequential order. An additional complicating factor here is where the time for providing a service cannot be estimated or can be estimated only with difficulty, which makes scheduling firm appointments impossible.

A problem which poses itself here is that equipment with the aid of which a service is provided also consumes energy during idle periods.

An example of a service provider to whom/which this state of affairs frequently applies is a doctor or a hospital who/which needs various equipment in order to provide a service to the patient, for example X-ray equipment, ultrasound equipment, computer tomographs, equipment in an operating theatre, etc. Essentially, this equipment can as a rule be used to examine or treat only one patient at a time, which is why a sequential arrangement has to be made for multiple patients.

A further example of a service provider is a transport company, for example an airline company, which can process its air passengers at the desk only in sequential order. The equipment necessary for the service in this case includes electronic scales, conveyor belts, card readers, computers, etc.

A final example to be cited here is that of an administrative body which provides a service to the citizen only in sequential order and to do so needs equipment such as computers, printers, typewriters and calculators as well as office equipment of a general type.

The equipment which is necessary for providing a service can also be ancillary equipment which, while not in itself directly involved in the provision of a service, can nonetheless be assigned to a service provider and is connected with the provision of a service.

Examples which can be given here are the lighting and heating or cooling of the service provider's premises which constantly consume energy irrespective of whether a service is currently being provided or not. This means that the faster a service provider can provide its service, the less energy is consumed by the infrastructure required for doing so.

A hairdresser will therefore be given as a further example of a service provider which can similarly only process customers in sequential order. While the problems of unnecessary energy consumption are less obvious here than in the examples mentioned previously, since an electric hair-cutting machine, for example, consumes de facto no energy when switched off, the problems of ancillary energy-consuming equipment apply equally here.

Furthermore, a service provider does not necessarily have to be a person in the real sense. Rather, an automatic machine which by virtue of its design processes essentially processes service users sequentially can also be designated as a service provider. Submodules of the automatic machine can be interpreted in this case as equipment for providing the service.

An example of this is a car wash facility, which is generally provided only for the sequential washing of multiple cars. Energy-consuming submodules in this case are, for example, pumps, compressors and various engines as well as the control unit of the car wash facility.

A further example is an unloading facility which discharges the load of freight trains or ships, for example containers, and automatically loads them onto trucks. The unloading facility can in this case be seen as a service provider and the trucks as service users, while the loading process constitutes the service to be provided sequentially. It is also obvious in the case of an unloading facility that various devices consume unneeded energy permanently, that is when in a standby state.

It is noted that the examples cited do not in any way cover all conceivable cases of application but represent only a small section thereof.

It is also observed that a service provider can as a rule be subdivided into service sub-providers operating sequentially, even where, viewed overall, the service users are processed in parallel.

A hospital can be cited as an example of this, whereby from an overall viewpoint multiple patients can of course be simultaneously treated, but which can be divided into separate departments, treatment rooms or sets of equipment, in which or with the aid of which patients, viewed individually, are treated sequentially.

Besides, a service can at times also be provided simultaneously for multiple service users without this calling into question the fact of increased energy consumption.

Thus, for example, two or more airline passengers can check in at one desk without this altering the problems faced. Firstly, everything stated naturally remains applicable to individual airline passengers and secondly, the principle mentioned can in conceptual terms also readily be extended to groups of service users, in this case airline passengers. Therefore, unnecessary energy is also consumed when groups of service users are processed sequentially and a group is not ready to use a service.

One approach to solving the problem of reducing energy consumption is then to provide for equipment an idle state in which less energy is consumed than in the operating state. Thus, if a service user is not ready to use a service, the equipment assigned to the service provider, which equipment is necessary for providing the service, is set to an idle state. It is nonetheless essentially the case here that—though to a more limited extent because of the idle state—energy is consumed unnecessarily.

It is therefore also possible to switch equipment off completely if a service user is not ready for using a service. At the same time it must be borne in mind that increased energy consumption can also result from any necessary initialization phase in which for example adjustment or warm-up processes are carried out, quite apart from the fact that cyclical warm-up and cool-down processes generally have a negative impact on the expected service life of equipment.

Likewise, the lighting and heating or cooling of a service provider's premises also constantly consume energy, as previously mentioned, irrespective of whether a service is currently being provided or not.

Another approach to solving the problem therefore consists in ensuring that the service users are ready to use a service in as uninterrupted a sequential order as possible. Unnecessary idle times in which, as has been shown, energy is consumed are avoided by this means.

A number of methods for sequencing service users are known from the prior art, such as for example the allocation of numbers by the service provider and the sequential calling of these numbers. Such systems require the physical presence of the service user at the service provider's, at least for the issuing of the numbers and when an appointment actually takes place. Service users, however, leave the service provider's premises, particularly where waiting times are long, and are therefore possibly not present at the time of their being called. Service providers are therefore again confronted with the problem that a service user, possibly despite agreeing an appointment, is not ready to use a service. This applies in particular to variable appointments, i.e. if for example an appointment is brought forward for certain reasons during the absence of a service user.

Methods are therefore also known in which an address of the service user in a telecommunications network is assigned to an appointment and a service user is informed about the actual occurrence of an appointment via this address. Examples of this include flight information systems or information systems for bus and rail which inform the airline or bus/rail passengers via the Short Message Service, SMS for short, about possible delays in or the bringing forward of a transport service.

In practice, however, the notification frequently occurs at a time at which certain activities can no longer be optimally organized by the service user during his/her absence, so that an appointment can again not be taken up. Thus, it is for example conceivable for a service user to miss the departure of a means of public transport to the service provider, which he/she would have to use in order to arrive in good time, because he/she was informed too late about an appointment, even if this is carried out via telecommunications equipment.

Such queuing systems are also known in the field of customer information. Here, a call by a service user is sequenced and the connection then interrupted again. Only when the service provider, in this case an employee in a call center, is ready is a call to the service user established and the service subsequently provided. Since, however, the service user does not have physically to attend the service provider's premises him-/herself for the service to be provided, systems of this type are not suited to service providers within the meaning of the invention.

The object of the invention is therefore to specify a method and a device for energy saving in equipment of a service provider, whereby the service users are ready to use a service in a largely uninterrupted sequential order.

This occurs according to the invention in a method of the type specified in the introduction,
wherein an anticipated travel time of the service user is additionally assigned to an appointment and
wherein a message concerning the appointment is transmitted to an address of the service user prior to the appointment, the appointment and the anticipated travel time being taken into account in determining the transmit time.

It is advantageous here that the equipment of the service provider can be used optimally and consequently only the minimum possible energy has to be expended for it to operate. Apart from the energy saving which emerges through the efficient processing of service users, reduced energy consumption also-results from the fact that the service provider, in addition, has to provide no, or only comparatively limited, premises for waiting service users, and smaller premises need less energy for lighting and heating or cooling. This system is known in the management context by the term “just in time”. The service user thus appears at the service provider's when the latter is actually ready to provide its service.

In order to be able also to guarantee the punctual appearance of the service user, a travel time is assigned to this service user in the queue, which travel time the service user needs in order to reach the service provider. Taking into account the travel time and the appointment, an appropriate reminder of the appointment is consequently sent in good time to the service user. In the simplest case; the travel time and possibly a tolerance time, for example ten minutes, is deducted from the time of the appointment in order to determine the transmit time. In principle, however, other methods are also conceivable.

For the notification, it is feasible here on the one hand for a call by an automatic voice recording to be made to the specified address, while on the other hand the transmission of a text message is also possible. Because of the plethora of options, only some will be mentioned by way of example here, such as an SMS message or an e-mail. So-called “push services” for HTML or WML pages are also conceivable. In this case, the display of the relevant page is not initiated by the user of the display device, i.e. in this case the service user, but is prompted by the service provider. Because of the nature of the invention, besides the use of wire-bound subscriber connections, use is made above all of connections in mobile radiocommunications networks for notification. Conceivable user terminals for the service user thus include GSM and UMTS mobile telephones, as well as laptops, PCs and personal digital assistants, known in short as PDAs.

The system can therefore be used either simply for reminding people of fixed appointments or else for coordinating changing appointments efficiently, as frequently occurs with doctors, administrative bodies, hospitals and other offices of a similar nature. It should once again be pointed out that a service provider is not necessarily a person, but a service provider can also be understood as being a machine. An example of this would be the coordination of scheduled times for the car wash facility or unloading facility mentioned previously.

It is also important that the service provider does not necessarily have to be a subscriber in a telecommunications network. Rather, a facility must simply be provided for the system on which the method according to the invention is running to send a message to an address in a telecommunications network. Finally, in place of a single address, multiple addresses to which a message is to be sent can also be specified.

It is further noted that the method according to the invention does not necessarily have to operate on the device whose energy consumption is to be cut. Rather, multiple devices can be combined into a group, which is managed with the aid of a shared queue.

It is advantageous if the appointment is entered as a result of a call by the service user or on the basis of the receipt of a text message from the service user.

In this variant, it is not necessary for the service user to appear in person at the service provider's in order to agree an appointment. The relevant entry in the queue is generated here for example with the aid of an automatic voice recording, which requests the information required from the service user, or else by means of the analysis of a received text message, such as an SMS message or an e-mail. Entry of the service user in an appropriate field on a WAP page or an web page of the service provider is also conceivable.

It is also advantageous if the anticipated travel time is determined automatically with the aid of the location of the service user at the time of the call or at the time of transmission of the text message.

The determination of the location of a subscriber in a telecommunications network is on principle known and not the subject matter of the invention. The location determined is needed in this context only for automatically determining the anticipated travel time. If a distance of several hundred meters is identified between the location of the service user and that of the service provider, then it can generally be assumed that the appearance of the service user at the service provider's will be possible within a few minutes.

If a call number transmitted in the course of connection establishment is a wire-bound subscriber line, it can be assumed that the service user is currently at home or possibly in the office and that the service user will probably travel to the service provider directly from there. A customer database at the service provider's can provide additional information here.

A particularly advantageous variant of the invention is offered by a method
wherein the current location of the service user is determined continuously and
wherein the anticipated travel time is continuously updated with the aid of this location.

Using this variant of the invention, it is possible to update the travel time continuously according to the location of the service user. This is particularly advantageous in cases where the service user is to be found at different locations during the waiting period. If ten minutes is selected as the refresh time for the updating, for example, then the maximum delay of the service user will be approximately the same.

It is also advantageous if a means of transport available to the service user and in particular the current traffic situation are taken into account in determining the anticipated travel time.

In this case, for example, a means of transport which the service user would like to use is also assigned to the entry in the waiting list. The anticipated travel time is consequently determined according to the means of transport, in the case of a car, for example, from the distance between service user and service provider and an anticipated average speed, for example 50 km/h. It is also conceivable here that the current traffic situation be taken into account, for example known traffic jams or appropriate consideration of the general reduction in speed at peak traffic times.

In the case of a public means of transport, since travel takes place only at defined times, the timetable can additionally be taken into account, so that the appointment is not missed, for example, due to a missed bus. Optionally, the service user can in the course of the notification concerning the appointment also be informed about a preferable means of transport to be used, for example by specifying the departure time of a train on a certain line. Particularly if the service user is traveling on foot in areas with a high density of public means of transport, substantial differences can occur here in the anticipated travel time, depending on the means of transport selected.

A particularly advantageous embodiment of the invention is also provided if the anticipated time of the actual occurrence of an appointment is continuously calculated and communicated to the service user continuously and/or on request.

In order to enable the service user to plan activities during his/her waiting period, the service user can also be informed continuously, or when he/she actively requests this, about the current appointment. Depending on the length of the postponement, activities can then be taken up or cancelled. In this way, it can be made easier still for the service user to appear punctually at the service provider's.

The object of the invention is also achieved in a device for energy saving in equipment of a service provider which, with the aid of this equipment, provides a service in at least partially sequential order to multiple service users, comprising
a queue,
means for entering an appointment, in particular a variable appointment, of a service user with the service provider into this queue and
means for assigning an address of the service user in a telecommunications network to this appointment, wherein
this device comprises means for assigning a travel time to this appointment and
means are provided for transmitting a message concerning the appointment and means for taking into account the appointment and the anticipated travel time in determining the transmit time of the message.

The advantages listed for the method according to the invention also apply equally to the device according to the invention in accordance with the independent Claim, as well as to all the subclaims. It is conceivable for example that the necessary means are part of a private branch exchange or part of a server prepared for this in a data network. In principle, the means may, however, also be present in a telecommunications network in distributed form.

It is advantageous if this device comprises means for entering an appointment as a result of a call by the service user or based on the receipt of a text message from the service user.

As already described, this variant of the invention is suitable for accepting an appointment agreement by phone or text message.

It is also advantageous if this device comprises means for automatically calculating the anticipated travel time using the location of the service user at the time of the call or at the time of transmission of the text message.

In order to make it easy to assign the anticipated travel time to an appointment, the device can comprise means for automatically calculating the travel time. The means for determining the location do not in this case have to be covered by the device according to the invention.

A particularly advantageous embodiment of the device according to the invention is also provided if this embodiment comprises means for continuously recording the current location of the service user and means for continuously updating the anticipated travel time with the aid of this location, in particular taking into account a means of transport available to the service user and in particular the current traffic situation.

As previously mentioned, the location of the service user and the associated anticipated travel time can continuously be updated. Here, account can be taken of the means of transport used by the service user, both private and public. This device thus provides the service user with a particularly convenient service.

It is also advantageous if this device comprises means for continuously calculating the anticipated time of the actual occurrence of an appointment and means for transmitting this time to the service user, continuously and/or based on a request.

In this device an information source is created for the service user, enabling said service user to coordinate his/her activities optimally during the waiting period.

Finally, it is also particularly advantageous if these means are part of a private branch exchange or information office integrated within an exchange.

This is of particular advantage to those service providers which on economic or technical grounds do not operate their own private branch exchange or information office. This gives these service providers the opportunity to utilize the invention cost-effectively and with limited technical outlay. For a private branch exchange integrated within an exchange the CENTREX standard, for example, prevails.

The invention will be described in detail with reference to an exemplary embodiment meeting the requirement of a service according to the invention, as shown in the drawings, in which

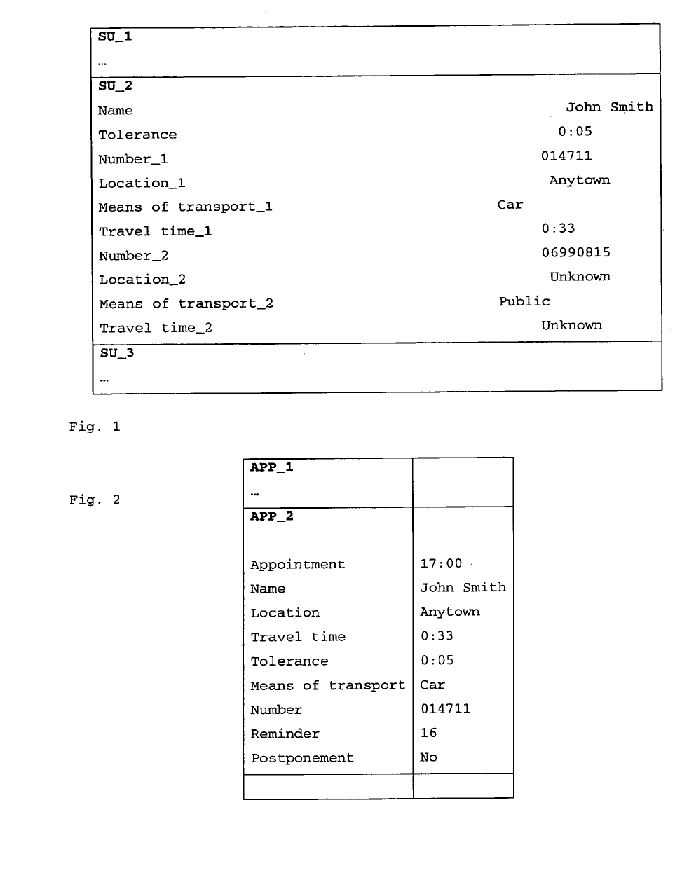

FIG. 1 shows an example of a database of the service provider SP with regard to service users SUx known to the service provider;

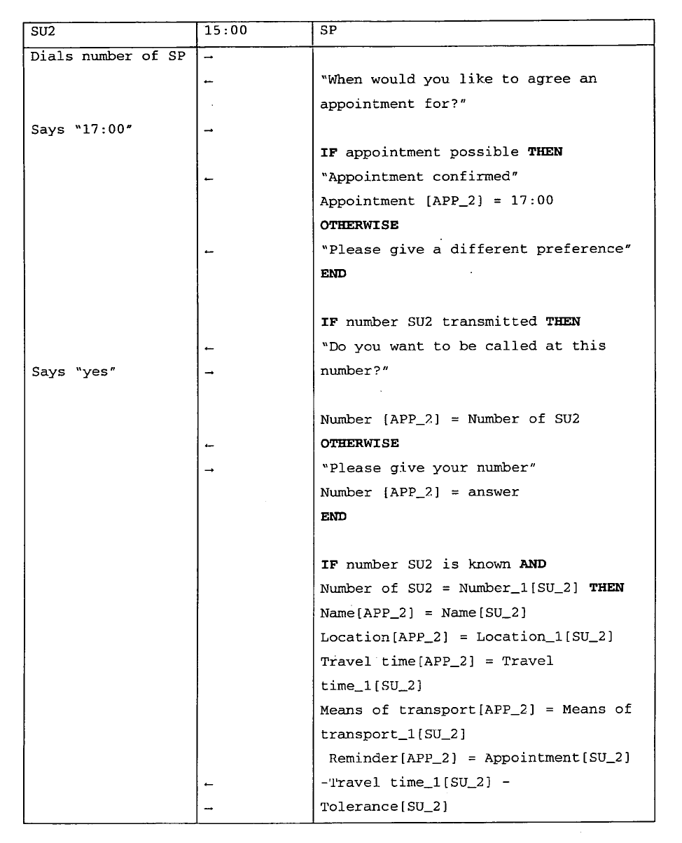

FIG. 2 shows an example of a queue Q relating to the appointments of the service users SUx;

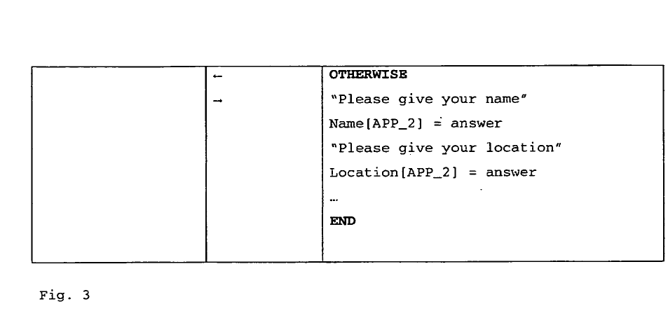

FIG. 3 shows the way in which the method according to the invention for agreeing an appointment functions and

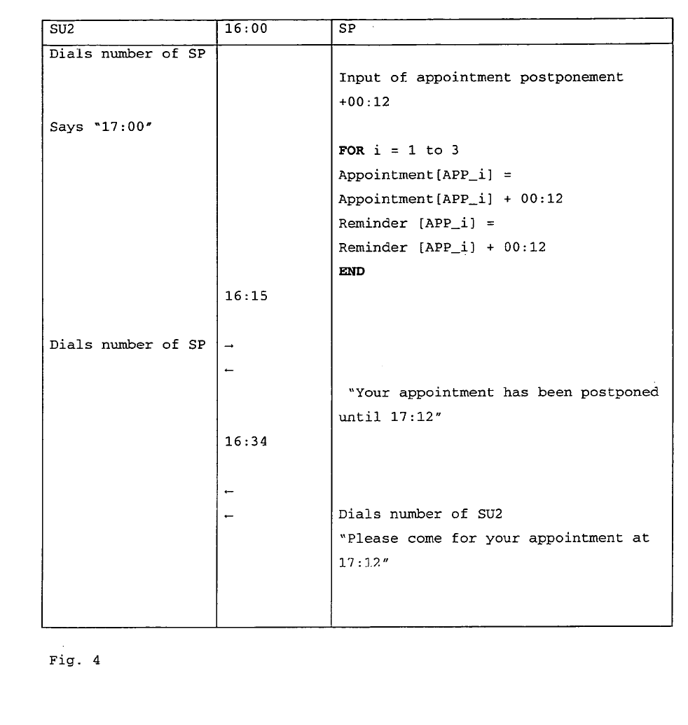

FIG. 4 shows the system for postponing an appointment, requesting an appointment and notifying the service user SUx.

FIG. 1 shows an example of what a database of the service provider SP relating to its known service users SUx could look like. For the purposes of greater clarity, the database, which is shown in the form of a table, comprises here only a first to a third entry SU_{—}1 . . . SU_{—}3, one entry SU_x being assigned to one service user SUx in each case. Each entry SU_x contains by way of example the following data fields:

| | |
|---|---|
| Name: | name of the service user SUx |
| Tolerance: | tolerance time |
| Number_1: | first telephone number of the service user SUx |
| Location_1: | location assigned to the first telephone number |
| Means of transport_1: | means of transport assigned to the first |
| | telephone number |
| Travel time_1: | travel time assigned to the first telephone |
| | number |
| Number_2: | second telephone number of the service user SUx |
| Location_2: | location assigned to the second telephone number |
| Means of transport_2: | means of transport assigned to the second |
| | telephone number |
| Travel time_2: | travel time assigned to the second telephone |
| | number |

For the second service user SU2, data is entered in FIG. 1 by way of example, it being assumed that the second service user SU2 has two subscriber lines in a telecommunications network. The first telephone number Number_{—}1, 014711, represents in this case a terminal connection in a wire-bound network, the second telephone number Number_{—}2, 06990815, a terminal connection in a mobile radiocommunications network. Since the terminal connection in-the wire-bound network is stationary, a first location Location_{—}1 can be assigned directly to this terminal connection. Moreover, it is known that the second service user SU2 normally travels by car from this first location Location_{—}1 and needs 33 minutes to do so. The appropriate data is therefore entered for the first means of transport Means of transport_{—}1 and the first travel time Travel time_{—}1. Since the terminal connection in the mobile radio communications network does not have this property, both the second location Location_{—}2 and the second travel time Travel time_{—}2 are, by contrast, initially unknown.

FIG. 2 shows an exemplary embodiment of a queue Q in which the appointments of the service users SUx are entered in chronological sequence. It is therefore not mandatory for the second appointment to be assigned to the second service user SU2. For greater clarity, the queue Q, which is shown in the form of a table, comprises here only a first to a third entry APP_{—}1 . . . APP_{—}3, each entry APP_x containing by way of example the following data fields:

| | |
|---|---|
| Appointment: | time of the appointment |
| Name: | name of the service user SUx |
| Location: | location assigned to the telephone number |
| Travel time: | travel time assigned to the telephone number |
| Tolerance: | tolerance time |
| Means of transport: | means of transport assigned to the telephone |
| | number |
| Number: | telephone number to which messages are to be sent |
| Reminder: | time agreed |
| Postponement: | indicates whether appointment postponements are |
| | to be notified |

FIG. 3 shows the way in which the method according to the invention for agreeing an appointment functions:

At 15:00 the second service user SU2 selects the number of the service provider SP. The system installed with the service provider SP subsequently enquires for what time an appointment is to be agreed. The second service user SU2 responds to the question with “17:00”. The system then checks whether the appointment is still available. In the present example, this is the case, so that “17:00” is entered for the appointment [APP_{—}2] as per FIG. 2. If, on the other hand, the appointment is no longer available, the service user SUx is requested to indicate another appointment. Since this is not the case in the present example, the corresponding field in the flow diagram is shaded.

It is subsequently checked whether the number of the second service user SU2 was transmitted by the telecommunications network, for example with the-aid of the service “Calling Line Identification Presentation”, or CLIP for short. This is the case in the example, which is why the system queries whether a notification is to be sent to this number. The second service user SU2 answers “Yes” to this question. The transmitted number of the second service user SU2, here 014711, is therefore entered in the field Number [APP_{—}2] as per FIG. 2. If no number was transmitted or if a notification is to be sent to a different number, then the service user is requested to specify a different number. Since this is not supposed to be the case in the present example, the corresponding area is again shaded.

The system subsequently checks whether the number can be assigned to a known service user SUx. To this end, the table as per FIG. 1 is searched. In the present case, the second entry SU_{—}2 can be assigned to the transmitted number. Subsequently, the name, location, travel time and means of transport are therefore transferred from the entry SU_{—}2 to the entry APP_{—}2. Finally, the reminder time Reminder [APP_{—}2] is calculated. To do this, the travel time Travel time_{—}1[SU_{—}2] and additionally the tolerance time Tolerance[SU_{—}2] are deducted from the appointment[APP_{—}2]. The travel time corresponds here to the time which a service user SUx needs in order to go from his/her location to the location of the service provider SP. Exact determination of this time is not generally possible or is possible only with considerable outlay. This factor is taken into account by including the tolerance time. Through appropriate selection, the presence of a service user SUx at the service provider's SP can be assured. In addition, the behavior of a service user SUx in terms of to his/her punctuality in keeping appointments can be included in the tolerance time, if after multiple appointments it transpires, for example, that a service user SUx always arrives too late by a certain length of time.

If no entry can be assigned to the transmitted number in the database as per FIG. 1, then the corresponding data is requested by the system. This is shown in FIG. 3 by way of example for the name [APP_{—}2] and the location [APP_{—}2]. This branch of the method is followed in particular for service users SUx who are not yet known to the service provider SP. Therefore, the appropriate data can also be transferred directly into the table as per FIG. 1 so that this data is available at a later time, i.e. after an appointment has expired when, for example, the corresponding entry in the table as per FIG. 2 has been deleted.

The input of whether appointment postponements are to be notified by the system is not shown explicitly in FIG. 3. Nevertheless, “no” to this is entered in the table as per FIG. 2.

FIG. 4 shows the system beginning at the time 16:00, at which an appointment postponement of 12 minutes occurs. This postponement results for example from the fact that the processing of service users SUx takes longer than planned, which is why the subsequent appointments are postponed accordingly. The data required is communicated to the system, for example by manually inputting the start time and finish time of the provision of a service. The average length of time of service provision, for example, can be determined from this and used by the system to adjust an appointment. FIG. 4 shows that both the appointments [APP_i] and the reminder times Reminder[APP_i] are postponed by 12 minutes.

It is assumed that the second service user SU2 at 16:15 requires information about the current status of his/her appointment and therefore dials the number of the service provider SP. The system recognizes that the call number transmitted by the telecommunications network is already assigned to an appointment and therefore notifies the second service user that his/her appointment has been postponed to 17:12. The service user SU2 can thus coordinate his/her activities during the waiting time accordingly.

Since no further appointment postponements arise, the number of the second service user SU2 is dialed by the system at 16:34 and the message communicated to him/her that he/she should now go to the service provider SP in order to appear in good time for the appointment.

Notwithstanding the procedure shown, text messages can also be communicated in place of voice information. A desired appointment as per FIG. 3 is then entered for example via a web page provided for this purpose by the service provider SP. A notification as per FIG. 4 can for example be made via e-mail or SMS, although it must be taken into account here that the delivery time of the messages in this case is generally undefined. With a call, by contrast, it can be ascertained from the lifting of the handset by the called subscriber, here the second service user SU2, whether the message was able to be delivered to this called subscriber in good time. Instead of specifying the first telephone number Number_{—}1, the second service user SU 2 can also specify that he/she can be reached at Number_{—}2. It can be seen from the table as per FIG. 1 that both the location_{—}2 and the travel time_{—}2 are unknown. Only the means of transport is specified. When the appointment is input and/or continuously, the location of the second service user SU2 is therefore determined with the aid of an inquiry addressed to the mobile radiocommunications network. Appropriate methods for doing this are known. By means of a further inquiry to an operator of public means of transport, which inquiry comprises the current location of the second service user SU2 and the location of the service provider SP and the arrival time, it can be ascertained when the second service user SU2 has to use which means of transport in order to arrive in good time at the service provider's SP. Such inquiries to a server of a transport company are possible according to the prior art, for example via the Internet or else via SMS.

It is noted that the queue Q can of course be processed by multiple persons, for example employees of the service provider SP, with the aid of multiple devices. A division of the service users SUx between these persons can be made, for example based on the type of service to be provided or based on the workload distribution between these persons. It is also conceivable for multiple queues Q to be provided at the service provider's SP, for example one per processing person, these queues Q being accessible to service users SUx, possibly via a shared address. Both variants are possible embodiments of the general inventive principle. As well as the sequential ordering of service users SUx, other methods are of course also conceivable here for processing, such as for example prioritization of individual service users SUx on the basis of a characteristic listed under their ID or on the basis of the type of service to be provided.

1-10. (canceled)

11. A method for saving energy in equipment of a service provider, wherein the service provider uses the equipment for providing a service in at least partially sequential order to multiple service users, the method comprising:
entering an appointed time of a service user with the service provider in a queue;
assigning an address of the service user in a telecommunications network to the appointed time;
assigning an anticipated travel time of the service user to the appointed time; and
transmitting a message concerning the appointed time to the address prior to the appointed time, wherein
the appointed time and the anticipated travel time are taken into account for determining the point of time the message is to be transmitted.

12. The method according to claim 11, wherein the appointed time is entered as a result of a call by the service user or on the basis of the receipt of a text message from the service user.

13. The method according to claim 12, wherein the anticipated travel time is determined automatically with the aid of the location of the service user at the time of the call or at the time of transmission of the text message.

14. The method according to claim 11, wherein the current location of the service user is determined continuously and wherein the anticipated travel time is updated continuously with the aid of said location.

15. The method according to claim 12, wherein the current location of the service user is determined continuously and wherein the anticipated travel time is updated continuously with the aid of said location.

16. The method according to claim 13, wherein the current location of the service user is determined continuously and wherein the anticipated travel time is updated continuously with the aid of said location.

17. The method according to claim 13, wherein a means of transportation available to the service user is used for determining the anticipated travel time.

18. The method according to claim 17, wherein the current traffic situation is used for determining the anticipated travel time.

19. The method according to claim 14, wherein a means of transportation available to the service user is used for determining the anticipated travel time.

20. The method according to claim 11, wherein the anticipated time of an actual settlement of an appointed time is calculated continuously and communicated to the service user continuously and/or on request.

21. The method according to claim 12, wherein the anticipated time of an actual settlement of an appointed time is calculated continuously and communicated to the service user continuously and/or on request.

22. The method according to claim 13, wherein the anticipated time of an actual settlement of an appointed time is calculated continuously and communicated to the service user continuously and/or on request.

23. The method according to claim 11, wherein the appointed time is variable.

24. A device for saving energy in equipment of a service provider which, wherein the service provider uses the equipment for providing a service in at least partially sequential order to multiple service users, the device comprising:
a queue;
a mechanism for the entering of an appointment of a service user with the service provider in the queue;
a mechanism for assigning an address of the service user in a telecommunications network to the appointment;
a mechanism for assigning a travel time to the appointment;
a mechanism for transmitting a message concerning the appointment; and
a mechanism for taking into account the appointment and the anticipated travel time for determining the time the message is to be transmitted.

25. The device according to claim 24, further comprising a mechanism for automatically calculating the anticipated travel time by using the location of the service user at the time of request.

26. The device according to claim 25, wherein the request is accomplished be a phone call or a text message.

27. The device according to claim 24, further comprising:
a mechanism for continuously determining the current location of the service user; and
a mechanism for continuously updating the anticipated travel time with the aid of the location.

28. The device according to claim 27, wherein for updating the anticipated travel time a means of transport available to the service user is taking into account.

29. The device according to claim 27, wherein for updating the anticipated travel time the current traffic situation is taking into account.

30. The device according to claim 24, wherein the device is part of a private branch exchange or information office integrated within an exchange.
